(19) United States
(12) Patent Application Publication
(10) Pub. No.: US 2020/0344402 A1
(43) Pub. Date: Oct. 29, 2020

(54) IMAGING DEVICE AND IMAGING SYSTEM

(71) Applicant: Nidec Copal Corporation, Tokyo (JP)

(72) Inventors: Taizo TAKIGUCHI, Tokyo (JP); Naoki INOUE, Tokyo (JP)

(21) Appl. No.: 16/857,180

(22) Filed: Apr. 24, 2020

(30) Foreign Application Priority Data
Apr. 26, 2019 (JP) 2019-085129

(51) Int. Cl. H04N 5/232; H04N 5/225; G08B 13/196

(52) U.S. Cl. CPC H04N 5/23203; H04N 5/2254; G08B 13/19669; G08B 13/19658; G08B 13/19602; G08B 13/19695; H04N 5/22521; G08B 13/19626

(57) ABSTRACT

An imaging device can capture images in an intended situation while providing privacy protection. The imaging device includes an imaging unit that captures an image, a lens barrier that opens and closes the imaging unit, a lens barrier driver that drives the lens barrier, a voice sensor that recognizes a voice, and an information processor that controls the lens barrier driver to open the lens barrier in response to the voice sensor recognizing a predetermined voice.

### BACKGROUND

### Technical Field

An aspect of the present invention relates to, for example, an imaging device including a lens barrier that is open based on, for example, a result of voice recognition.

### Description of the Background

Surveillance cameras have been installed against crimes or other issues. Some surveillance cameras may operate upon detecting a person within an imaging area, rather than operating constantly. For example, an intercommunication system for multi-family residentials described in Patent Literature 1 includes a camera for identifying a visitor that is activated in response to a human sensor detecting the visitor to capture an image of the face of the visitor.

### CITATION LIST

### Patent Literature

Patent Literature: Japanese Unexamined Patent Application Publication No. 2008-208656

### BRIEF SUMMARY

For privacy protection nowadays, surveillance cameras constantly capturing images may be resisted or may be limited under some regulations. The technique described in Patent Literature 1 may thus be used for a camera to capture images simply in response to a human sensor detecting a person.

However, a camera that captures images in response to a human sensor detecting a person may capture unintended images with insufficient privacy protection. A camera located in a busy place may capture and record images for a long time. From such images, finding an intended image may be time-consuming. Thus, an imaging device is to capture a minimum number of images and provide privacy protection.

In response to the above issue, one or more aspects of the present invention are directed to the structures described below. The reference numerals or other labels in parentheses herein denote the corresponding components in the figures to facilitate understanding of the aspects of the present invention. However, the components with such reference numerals do not limit the components according to the aspects of the present invention, which should be construed broadly within the scope technically understandable by those skilled in the art.

An imaging device (1) according to one aspect of the present invention includes an imaging unit (11) that captures an image, a lens barrier (12) that opens and closes the imaging unit, a lens barrier driver (16) that drives the lens barrier, a voice sensor (17) that recognizes a voice, and an information processor (10) that controls the lens barrier driver to open the lens barrier in response to the voice sensor recognizing a predetermined voice.

The imaging device with the above structure includes the lens barrier that is open when, for example, recognizing a predetermined voice such as a scream of a person or a voice asking for help, and thus enables image capturing in an intended situation while providing privacy protection. The lens barrier in the imaging device can be closed in situations unintended to capture images. In this structure, the imaging unit can avoid constantly receiving light and can thus reduce degradation of an image sensor or other components in the imaging unit. The lens barrier can also reduce entry of foreign matter such as dust or liquid into the imaging unit. The lens barrier is closed when the image capturing is disabled, being externally viewable for determining whether the images are being captured. In a crime scene, for example, a person concerned can notice that his or her images are being captured. This may discourage, for example, the person from committing a crime. In a non-crime scene, nearby persons can notice that images are not being captured, possibly providing a feeling of relief.

In the above imaging device, the information processor may control the lens barrier driver to open the lens barrier in response to the voice sensor recognizing a predetermined keyword.

The imaging device with the above structure enables image capturing when, for example, recognizing a voice asking for help or a keyword relating to crimes such as a fraud. The imaging device can thus more effectively capture images in an intended situation while providing privacy protection.

In the above imaging device, the information processor may control the lens barrier driver to open the lens barrier in response to the voice sensor recognizing a voice of a predetermined volume or larger.

The imaging device with the above structure can capture images when, for example, recognizing a scream of a person or a sound of a traffic accident. The imaging device can thus more effectively capture images in an intended situation while providing privacy protection.

An imaging device (1) according to another aspect of the present invention includes an imaging unit (11) that captures an image, a lens barrier (12) that opens and closes the imaging unit, a lens barrier driver (16) that drives the lens barrier, an odor sensor (18) that detects an odor, and an information processor (10) that controls the lens barrier driver to open the lens barrier in response to the odor sensor detecting a predetermined odor.

The imaging device with the above structure includes the lens barrier that is open when, for example, recognizing an odor of a specific person, and thus enables image capturing in an intended situation while providing privacy protection. The lens barrier in the imaging device can be closed in situations unintended to capture images. In this structure, the imaging unit can avoid constantly receiving light and can thus reduce degradation of an image sensor or other components in the imaging unit. This structure can also reduce entry of foreign matter such as dust and liquid into the imaging unit. The lens barrier is closed when the image capturing is disabled, being externally viewable for determining whether the images are being captured. In a scene including a visit by a specific person, the visitor can notice that his or her images are being captured. This may discourage, for example, the visitor from committing a crime. In a non-crime scene, the visitor can notice that images are not being captured, possibly providing a feeling of relief.

An imaging device (1) according to another aspect of the present invention includes an imaging unit (11) that captures an image, a lens barrier (12) that opens and closes the imaging unit, a lens barrier driver (16) that drives the lens barrier, a vibration sensor (19) that detects vibrations, and an information processor (10) that controls the lens barrier driver to open the lens barrier in response to the vibration sensor detecting vibrations.

The imaging device with the above structure includes the lens barrier that is open when, for example, detecting a visitor with vibrations or an accident with a shock, and thus enables image capturing in an intended situation while providing privacy protection. The lens barrier in the imaging device can be closed in situations unintended to capture images. In this structure, the imaging unit can avoid constantly receiving light and can thus reduce degradation of an image sensor or other components in the imaging unit. This structure can also reduce entry of foreign matter such as dust and liquid into the imaging unit. The lens barrier is closed when the image capturing is disabled, being externally viewable for determining whether the images are being captured.

An imaging device (1) according to another aspect of the present invention includes an imaging unit (11) that captures an image, a lens barrier (12) that opens and closes the imaging unit, a lens barrier driver (16) that drives the lens barrier, a human sensor (20) that detects a human body, and an information processor (10) that controls the lens barrier driver to open the lens barrier in response to the human sensor detecting a human body.

The imaging device with the above structure includes the lens barrier that is open to capture images in response to the human sensor detecting a visitor, and thus enables image capturing in an intended situation while providing privacy protection. The lens barrier in the imaging device can be closed in situations unintended to capture images. In this structure, the imaging unit can avoid constantly receiving light and can thus reduce degradation of an image sensor or other components in the imaging unit. This structure can also reduce entry of foreign matter such as dust and liquid into the imaging unit. The lens barrier is closed when the image capturing is disabled, being externally viewable for determining whether the images are being captured.

An imaging system according to another aspect of the present invention includes, in addition to the imaging device according to any one of the above aspects, a door openable and closeable. The imaging unit is installed adjacent to the door.

In the imaging system with the above structure, the imaging device according to any one of the above aspects of the present invention may be installed adjacent to a home or office door to capture images of visitors and passersby as appropriate. The imaging system may help reduce crimes near the home or the office or may be used to identify the causes of accidents.

In the above imaging system, a surface of the lens barrier facing a subject may be colored or has a sign or a pattern.

The imaging system with the above structure allows a person to more clearly notice whether his or her image is being captured. This may more effectively reduce crimes.

### BRIEF DESCRIPTION OF DRAWINGS

FIG. 1 is a block diagram of an imaging device according to an embodiment.

FIG. 2 is a flowchart showing the processing of the imaging device according to the embodiment.

FIG. 3 is a block diagram of an imaging device according to a first modification.

FIG. 4 is a flowchart showing the processing of the imaging device according to the first modification.

FIG. 5 is a block diagram of an imaging device according to a second modification.

FIG. 6 is a flowchart showing the processing of the imaging device according to the second modification.

FIG. 7 is a block diagram of an imaging device according to a third modification.

FIG. 8 is a flowchart showing the processing of the imaging device according to the third modification.

### DETAILED DESCRIPTION

An imaging device according to an embodiment of the present invention functions as, for example, an intercom installed adjacent to an entrance door or as a surveillance camera. The imaging device includes a lens barrier that is open to enable image capturing with an imaging unit in predetermined situations including when recognizing a voice such as a scream of a person or a voice asking for help. Although described later in detail, the imaging device with this structure can capture images in an intended situation while providing privacy protection. For example, the imaging device according to the present embodiment may capture images of visitors to an office or a home or may capture images of accidents that may occur in front of the door.

The imaging devices according to embodiments and modifications of the present invention will now be described in detail with reference to the drawings. The embodiments described below are mere examples of the present invention, and should not be construed as limiting the technical scope of the invention. In the figures, the same components are given the same reference numerals, and may not be described.

1. Embodiments

2. Modifications

(1) First Modification

(2) Second Modification

(3) Third Modification

3. Features

4. Supplemental Examples

### 1. Embodiments

### Structure of Imaging Device 1

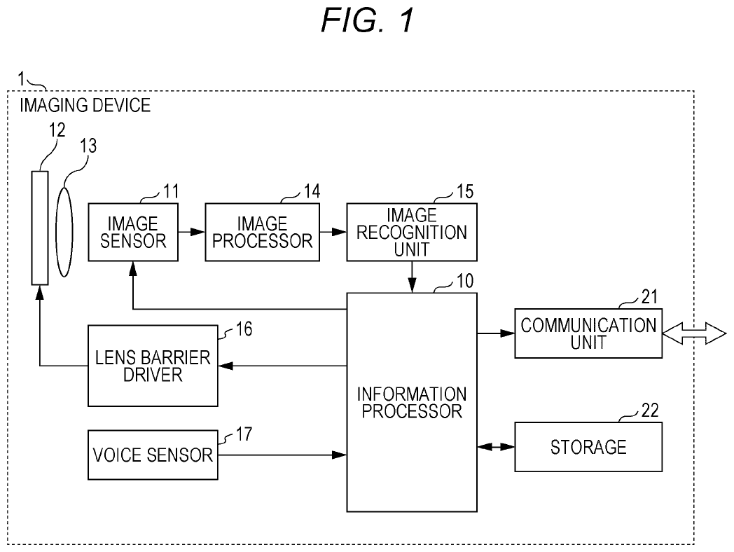

FIG. 1 is a functional block diagram of an imaging device 1 according to the present embodiment. As shown in FIG. 1, the imaging device 1 according to the present embodiment includes an image sensor 11, a lens barrier 12, a lens 13, an image processor 14, an image recognition unit 15, a lens barrier driver 16, a voice sensor 17, a communication unit 21, and a storage 22. The imaging device 1 according to the present embodiment may be installed, for example, adjacent to an entrance door, or may serve as a surveillance camera.

### Image Sensor 11

The image sensor 11 may be a charge-coupled device (CCD) or a complementary metal-oxide-semiconductor (CMOS) image sensor, and may be a photoelectric converter that can obtain images. The image sensor 11 outputs image signals obtained through image capturing to the image processor 14. The image sensor 11 may capture moving images or still images.

### Lens 13

The lens 13 is located between the image sensor 11 and the lens barrier 12 to focus light from a subject onto the image sensor. The lens 13 may include one or more lenses, or a lens group including at least two lenses. The lens 13 may include an optical element such as an infrared (IR) filter or a neutral density (ND) filter.

In the present embodiment, the image sensor 11 and the lens 13 correspond to an imaging unit. The imaging unit captures an image of a person or another object in front of the imaging device 1 as a subject.

### Lens Barrier 12

The lens barrier 12 is located between the lens 13 and the subject and can be open and closed. The lens barrier 12 is driven by the lens barrier driver 16 including a motor or another component to have its blades open or closed in front of the lens 13. When closed, the lens barrier 12 reduces light incident on the image sensor 11 and the lens 13, dust entering from outside, and dirt adhering to the lens 13 to protect the image sensor 11 and the lens 13. The lens barrier 12 is open under predetermined conditions described below and is closed in other situations. The image capturing is disabled while the lens barrier 12 is closed. The lens barrier 12 includes, for example, multiple blades, which are operated to cover and uncover the lens 13.

The outer surface (facing the subject) of the lens barrier 12 is colored with red or another color. Thus, a person in front of the imaging device 1 can visually recognize that the lens barrier 12 for protecting the lens 13 of the imaging device 1 is closed, and can notice whether his or her images are being captured. The outer surface of the lens barrier 12 may be colored with a color other than red, or may have a sign or a pattern instead. The lens barrier 12 may generate a large noise to allow a person in front of the imaging device 1 to easily notice that the lens barrier 12 is closed.

### Image Processor 14

The image processor 14 is, for example, an image signal processor (ISP). The image processor 14 converts images captured by the image sensor 11 into image data and outputs the image data to the image recognition unit 15.

### Image Recognition Unit 15

The image recognition unit 15 obtains, from the captured image data, facial data about the face of a person captured, and outputs the facial data together with the image data to an information processor 10. The facial data output from the image recognition unit 15 to the information processor 10 is data for identifying the captured person, and includes multiple features of the face of the person as the subject.

### Lens Barrier Driver 16

As controlled by the information processor 10, the lens barrier driver 16 opens or closes the lens barrier 12. The lens barrier driver 16 may be a motor directly or indirectly connected to the blades of the lens barrier 12.

### Voice Sensor 17

The voice sensor 17 obtains voices around the imaging device 1 and outputs the obtained voice data to the information processor 10. The voice sensor 17 may include, for example, a microphone and an amplifier. The voice sensor 17 may obtain a voice in front of the imaging device 1 for capturing an image with its imaging unit. The voice sensor 17 may include a microphone with directivity.

### Communication Unit 21

The communication unit 21 transmits and receives data through wired or wireless communication to and from a device such as an external server. For example, the communication unit 21 transmits a notice to a mobile phone of a user when a preregistered person is recognized. The communication unit 21 also transmits, for example, obtained image or voice data to an external server when receiving a request from the external server to transmit the obtained image or voice. The communication unit 21 may transmit image data to destinations other than an external server.

### Storage 22

The storage 22 may be a storage device such as a rewritable semiconductor memory or magnetic memory. The storage 22 prestores, as registered voices, data representing predetermined voices that trigger the operation of the imaging unit to start image capturing. More specifically, the storage 22 stores keywords such as predetermined words or risk predictive words. Examples of the predetermined words include words used to call a person or a countersign. Examples of the risk predictive words include a scream of a person, bullying words used to bully a person, threat words used to threaten a person, and help words used to ask for help.

Examples of a scream of a person include voices such as “yaaa” and “eek”. Examples of the bullying words and threat words include “hey, you” and “wait”. Examples of the help words include voices such as “help” and “someone”.

The storage 22 stores identification information for identifying, through pattern recognition, a captured person. The identification information includes data about the features of the faces of multiple persons.

The storage 22 stores images captured by the image sensor 11.

### Information Processor 10

The information processor 10 is a central processing unit (CPU) in the imaging device 1. The information processor 10 may be, for example, a semiconductor integrated circuit. The information processor 10 compares voice data obtained by the voice sensor 17 with the registered voices stored in the storage 22 to determine whether the obtained voice matches any of the registered voices. When the obtained voice matches any of the registered voices, the information processor 10 activates the lens barrier driver 16 to open the lens barrier 12 to enable image capturing, and then activates the image sensor 11 to capture an image in front of the imaging device 1. The image to be captured may be a still image or a moving image. The information processor 10 stores image data for the captured image into the storage 22.

The information processor 10 compares the facial data of the person input from the image recognition unit 15 with identification information stored in the storage 22 to determine whether the captured person matches any of the preregistered persons. When the captured person matches any of the preregistered persons, the information processor 10 transmits, to a mobile phone of a user via the communication unit 21, a notice that the imaging device 1 has captured an image of the person. More specifically, the information processor 10 transmits a notice to warn a user via the communication unit 21 when the captured person is an unwanted person such as a stalker.

A person may be identified using a voice obtained by the voice sensor 17 to replace facial recognition using an image.

The functions of the information processor 10 will be described in detail in the operational example below.

The information processor 10 may be a single semiconductor integrated circuit incorporating one or more other components of the imaging device 1.

### Operational Example of Imaging Device 1

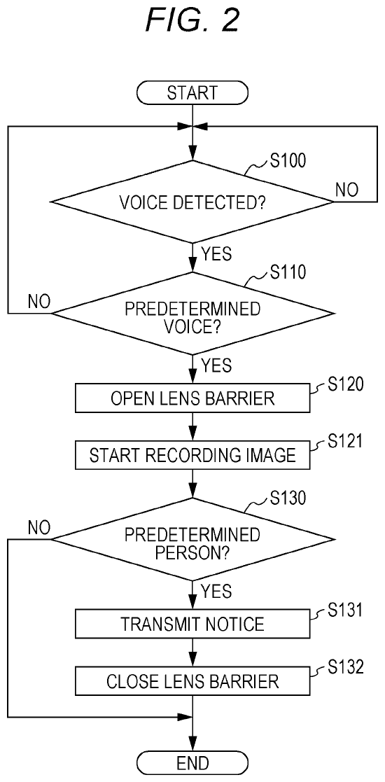

An operational example of the imaging device 1 will now be described with reference to the flowchart in FIG. 2. The processing described below relates to obtaining an image (moving or still image) through image capturing in response to the imaging device 1 detecting a predetermined voice and determining whether the captured person matches any of the preregistered persons.

### S100

The imaging device 1 continuously or intermittently operates to detect a voice around the imaging device 1 with the voice sensor 17 (S100).

### S110

When detecting a voice (Y in S100), the voice sensor 17 outputs the obtained voice data to the information processor 10. The information processor 10 compares this voice data with the registered voices stored in the storage 22 to determine whether the obtained voice matches any of the predetermined registered voices (S110). As described above, examples of the predetermined registered voices (keywords) include predetermined words, such as words used to call a person or a countersign, a scream of a person, bullying words, threat words, and risk predictive words such as help words. When the obtained voice matches none of the predetermined registered voices (N in S110), the voice sensor 17 reoperates to detect a voice.

### S120

When the obtained voice matches any of the predetermined registered voices (Y in S110), the information processor 10 activates the lens barrier driver 16 to open the lens barrier 12 (S120).

### S121

Subsequently, the information processor 10 activates the image sensor 11 to start recording an image in front of the imaging device 1 (S121). Although the image sensor 11 captures a moving image in the example described herein, the image sensor 11 may capture a still image. The image captured by the image sensor 11 is input to the image processor 14, and then input to the image recognition unit 15. The image recognition unit 15 obtains facial data about the face of a person contained in the captured image and outputs the facial data to the information processor 10 together with data for the captured image. The information processor 10 stores the received image data (moving or still image data) in the storage 22.

### S130

Subsequently, the information processor 10 compares the input facial data with identification information stored in the storage 22 to determine whether the captured image contains any of the preregistered persons (S130). When none of the preregistered persons is included in the persons captured (N in S130), the series of processes ends.

### S131

When determining that the captured image contains any of the preregistered persons (Y in S130), the information processor 10 transmits a notice to a mobile phone of a user via the communication unit 21 (S131). The user receives the notice and learns that the captured person stays at, for example, the entrance at which the imaging device 1 is installed.

### S132

Subsequently, the information processor 10 activates the lens barrier driver 16 to close the lens barrier 12 (S132). As described above, the outer surface of the lens barrier 12 is colored with red or another color. When the lens barrier 12 is closed, the captured person can notice that the lens barrier 12 is closed. The captured person learns that the imaging device 1 has captured his or her image. This may be effective in discouraging the person from committing a crime. When the lens barrier 12 is closed, the series of processes ends.

Through the above processes, images start being captured and recorded when a predetermined registered voice is detected. When the captured person matches any of the preregistered persons, a notice is transmitted to the user.

### Application of Imaging Device 1 According to Present Embodiment

The imaging device 1 according to the present embodiment may implement the functions described below.

For example, a resident who has a violent former husband may receive a visit of the husband saying “hey, you” at the entrance at which the imaging device 1 is installed. In this situation, the communication unit 21 automatically transmits a notice to the resident, the police, and other destinations.

The imaging device 1 may be installed at school to serve as a surveillance camera. The communication unit 21 may transmit, to teachers, a notice about bullying among students in, for example, a bathroom. The imaging device 1 can also provide a moving image of a bullying scene to be viewed by teachers.

### 2. Modifications

Modifications of the present embodiment will now be described. The present embodiment may be modified in various forms, some of which will be described below. The present embodiment and the modifications do not cover all the structures and operations of the present invention.

### (1) First Modification

The present modification differs from the present embodiment in an odor sensor 18 that replaces the voice sensor 17. The structure according to the present modification opens the lens barrier to start recording an image when a detected odor matches any of predetermined odors, but does not identify a captured person, unlike in the present embodiment. The differences between the present modification and the embodiment will be described below. The components, functions, and processes that are identical to those described in the embodiment may not be described.

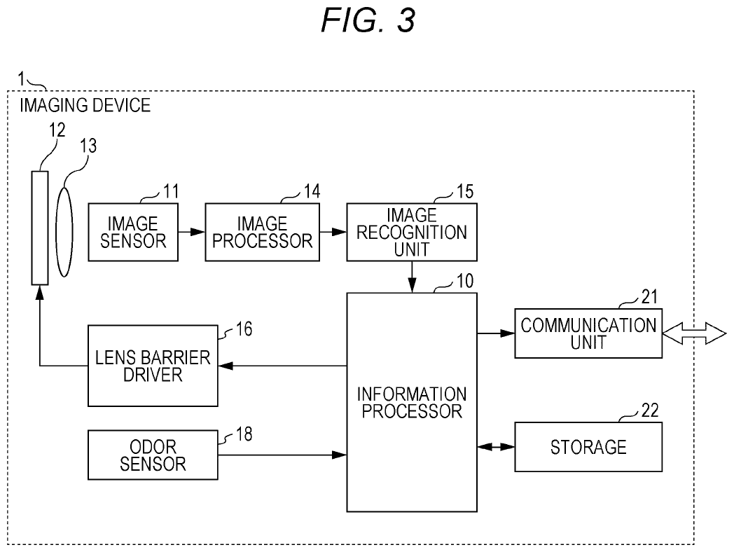

FIG. 3 is a functional block diagram of an imaging device 1 according to the present modification. As shown in FIG. 3, the imaging device 1 according to the present modification includes an odor sensor 18, in addition to an image sensor 11, a lens barrier 12, a lens 13, an image processor 14, an image recognition unit 15, a lens barrier driver 16, a communication unit 21, and a storage 22, which are similar to those described in the first embodiment. The imaging device 1 according to the present modification may be installed at places where hazardous chemicals are stored, in addition to being installed adjacent to an entrance door or installed as a surveillance camera.

### Odor Sensor 18

The odor sensor 18 detects odors around the imaging device 1 and outputs the detected odors to the information processor 10 as odor data. The odor sensor 18 may obtain an odor in front of the imaging device 1 for capturing an image with its imaging unit.

### Storage 22

The storage 22 prestores, as registered odors, data about predetermined odors that trigger the operation of the imaging unit to start image capturing. More specifically, the storage 22 stores a body odor of a predetermined person, an odor of a perfume used by a predetermined person, and an odor emitted when, for example, hazardous chemicals leak.

### Information Processor 10

The information processor 10 compares odor data obtained by the odor sensor 18 with the registered odors stored in the storage 22 to determine whether the odor emitted around the imaging device 1 matches any of the registered odors. When determining that the odor emitted around matches any of the registered odors, the information processor 10 activates the lens barrier driver 16 to open the lens barrier 12 to enable image capturing, and then activates the image sensor 11 to capture an image in front of the imaging device 1.

### Operational Example of Imaging Device 1

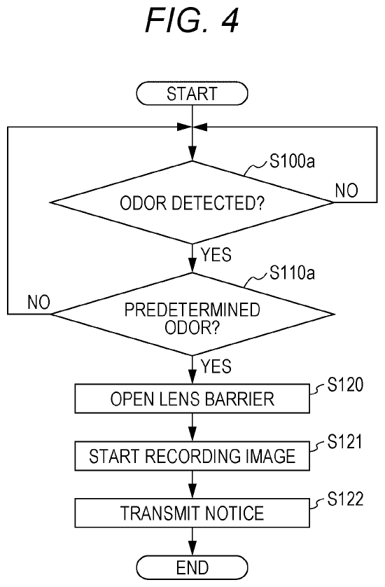

An operational example of the imaging device 1 according to the present modification will now be described with reference to the flowchart in FIG. 4. The processing described below relates to obtaining an image (moving or still image) through image capturing in response to the imaging device 1 detecting a predetermined odor.

### S100a

The imaging device 1 continuously or intermittently operates to detect an odor around the imaging device 1 with the odor sensor 18 (S100a).

### S110a

When detecting an odor (Y in S100a), the odor sensor 18 outputs odor data about the detected odor to the information processor 10. The information processor 10 compares this odor data with the registered odors stored in the storage 22 to determine whether the detected odor matches any of the predetermined registered odors (S110a). When the detected odor matches none of the predetermined registered odors (N in S110a), the odor sensor 18 reoperates to detect an odor.

### S120

When the detected odor matches any of the predetermined registered odors (Y in S110a), the information processor 10 activates the lens barrier driver 16 to open the lens barrier 12 (S120).

### S121

Subsequently, the information processor 10 activates the image sensor 11 to start recording an image in front of the imaging device 1 (S121). The image captured by the image sensor 11 is input to the image processor 14, and then input to the image recognition unit 15.

### S122

Subsequently, the information processor 10 transmits, to a mobile phone of a user via the communication unit 21, a notice that a preregistered odor is emitted around the imaging device 1 (S122). The user receiving the notice can learn the odor emitted around the imaging device 1.

### Application of Imaging Device 1 According to Present Modification

The imaging device 1 according to the present modification may implement the functions described below.

For example, the imaging device 1 installed at the entrance can automatically start capturing an image of an insistent salesperson. In this case, the storage 22 in the imaging device 1 prestores the odor of the salesperson.

For example, an offensive smell occurs at a warehouse storing hazardous chemicals where the imaging device 1 is installed. In this case, the imaging device 1 can transmit a notice about the offensive smell to a manager of the warehouse. When an offensive smell results from scattering garbage at the garbage collection area where the imaging device 1 is installed, the imaging device 1 can transmit a notice about the offensive smell to a manager. When an offensive smell occurs on a train with the imaging device 1 installed at a predetermined place, the imaging device 1 can transmit a notice to a conductor or a manager of the railway company.

### (2) Second Modification

The present modification differs from the present embodiment in a vibration sensor 19 that replaces the voice sensor 17. The present modification differs from the first modification in a vibration sensor 19 that replaces the odor sensor 18. The structure according to the present modification opens the lens barrier to start recording an image in response to the vibration sensor 19 detecting vibrations without determining whether the vibrations match predetermined vibrations. The differences between the present modification and the embodiment and the first modification will be described below. The components and functions identical to those described in the embodiment and the processes identical to those described in the embodiment and the first modification may not be described.

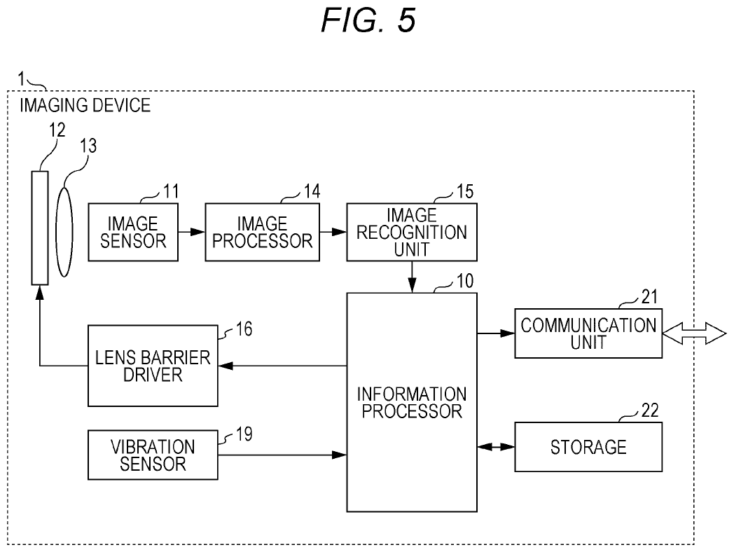

FIG. 5 is a functional block diagram of an imaging device 1 according to the present modification. As shown in FIG. 5, the imaging device 1 according to the present modification includes a vibration sensor 19, in addition to an image sensor 1, a lens barrier 12, a lens 13, an image processor 14, an image recognition unit 15, a lens barrier driver 16, a communication unit 21, and a storage 22, which are similar to those described in the first embodiment. The imaging device 1 according to the present modification may be installed adjacent to an entrance door or installed as a surveillance camera.

### Vibration Sensor 19

The vibration sensor 19 operates to detect vibrations around the imaging device 1. When detecting vibrations, the vibration sensor 19 transmits a notice to the information processor 10. The vibration sensor 19 detects vibrations of a predetermined magnitude or larger without detecting microvibrations caused by, for example, breeze. The vibration sensor 19 may detect vibrations in front of the imaging device 1 for capturing an image with its imaging unit. The vibration sensor 19 may be a shock sensor that detects a shock.

### Information Processor 10

In response to the vibration sensor 19 detecting vibrations, the information processor 10 activates the lens barrier driver 16 to open the lens barrier 12 to enable image capturing, and then activates the image sensor 11 to capture an image in front of the imaging device 1.

### Operational Example of Imaging Device 1

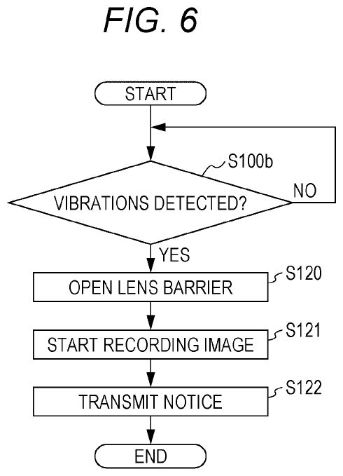

An operational example of the imaging device 1 according to the present modification will now be described with reference to the flowchart in FIG. 6. The processing described below relates to obtaining an image (moving or still image) through image capturing in response to the imaging device 1 detecting vibrations.

### S100b

The imaging device 1 continuously or intermittently operates to detect vibrations around the imaging device 1 with the vibration sensor 19 (S100b).

### S120

In response to the vibration sensor 19 detecting vibrations (Y in S100b), the information processor 10 activates the lens barrier driver 16 to open the lens barrier 12 (S120).

The subsequent processing is the same as in the first modification.

### Application of Imaging Device 1 According to Present Modification

The imaging device 1 according to the present modification may implement the functions described below.

For example, a shock is caused by a traffic accident at an intersection where the imaging device 1 is installed. In this case, the imaging device 1 may automatically start capturing an image.

For example, an earthquake or vibrations occur due to volcanic activity at a place where the imaging device 1 is installed as a surveillance camera. In this case, the imaging device 1 may automatically start capturing an image.

### (3) Third Modification

The present modification differs from the embodiment in an infrared sensor 20 that replaces the voice sensor 17. The structure according to the present modification opens the lens barrier to start recording an image in response to the infrared sensor 20 detecting a human body. The differences between the present modification and the embodiment and the first and second modifications will be described below. The components and functions identical to those described in the embodiment and the processes identical to those described in the embodiment and the first or second modification may not be described.

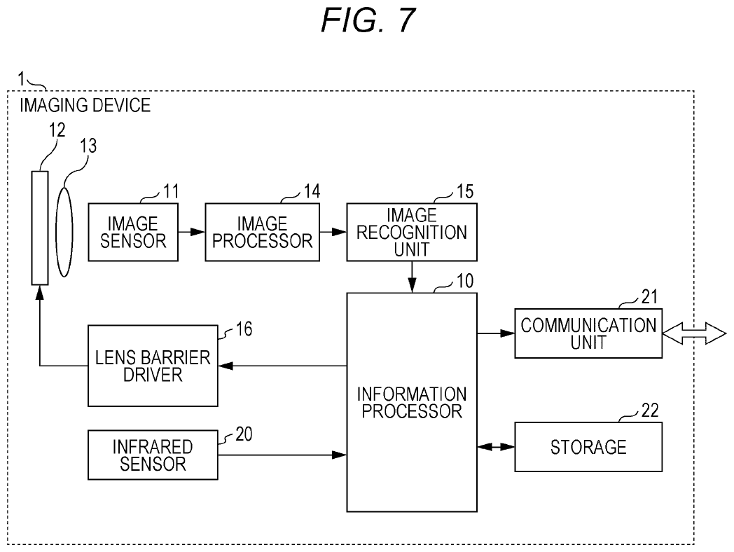

FIG. 7 is a functional block diagram of an imaging device 1 according to the present modification. As shown in FIG. 7, the imaging device 1 according to the present modification includes an infrared sensor 20, in addition to an image sensor 11, a lens barrier 12, a lens 13, an image processor 14, an image recognition unit 15, a lens barrier driver 16, a communication unit 21, and a storage 22, which are similar to those described in the first embodiment. The imaging device 1 according to the present modification is installed adjacent to an entrance door or installed as a surveillance camera.

### Infrared Sensor 20

The infrared sensor 20 is a type of human sensor that detects a human body in front of the imaging device 1. The infrared sensor 20 transmits a notice to the information processor 10 when detecting a human body.

### Information Processor 10

In response to the infrared sensor 20 detecting a human body, the information processor 10 activates the lens barrier driver 16 to open the lens barrier 12 to enable image capturing, and then activates the image sensor 11 to capture an image in front of the imaging device 1.

### Operational Example of Imaging Device 1

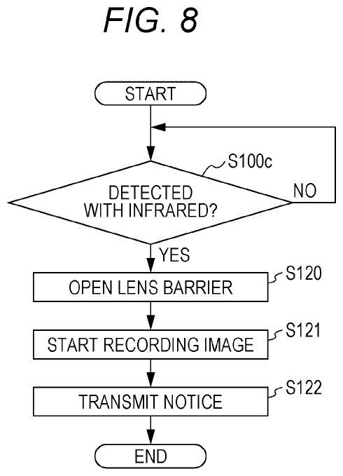

An operational example of the imaging device 1 according to the present modification will now be described with reference to the flowchart in FIG. 8. The processing described below relates to obtaining an image (moving or still image) through image capturing in response to the imaging device 1 detecting a human body with the infrared sensor 20. S100c

The imaging device 1 continuously or intermittently operates to detect a person in front of the imaging device 1 with the infrared sensor 20 (S100c).

### S120

In response to the infrared sensor 20 detecting a person (Y in S100c), the information processor 10 activates the lens barrier driver 16 to open the lens barrier 12 (S20).

The subsequent processing is the same as in the first modification.

### Application of Imaging Device 1 According to Present Modification

The imaging device 1 according to the present modification may implement the functions described below.

For example, the imaging device 1 installed at the entrance can start image capturing when a person appears in front of the entrance. The lens barrier 12 opens to start image capturing. Thus, the person in front of the entrance can notice that his or her image starts being captured.

### 3. Features

The embodiments and modifications of the present invention described above have the features described below.

The imaging device 1 according to the above embodiment performs processing in response to a voice obtained by the voice sensor 17 and opens or closes the lens barrier 12. The imaging device 1 can open the lens barrier 12 when, for example, recognizing a predetermined voice such as a scream of a person or a voice asking for help, and capture images in an intended situation while providing privacy protection. The imaging device 1 including the lens barrier 12 can close the lens barrier 12 in situations unintended to capture images. In this structure, the image sensor 11 can avoid constantly receiving light and can thus reduce degradation of the image sensor 11. This structure can also reduce entry of foreign matter such as dust and liquid into the imaging unit. The lens barrier 12 is closed when the image capturing is disabled, externally showing whether the image capturing operation is being performed. In a crime scene, for example, a person concerned can notice that his or her images are being captured. This may discourage, for example, the person from committing a crime. In a non-crime scene, nearby persons can notice that images are not being captured, possibly providing a feeling of relief.

The imaging device 1 according to the above embodiment opens the lens barrier 12 in response to the voice sensor 17 recognizing a predetermined keyword. Thus, the imaging device 1 can more effectively capture images in an intended situation while providing privacy protection.

The imaging device 1 according to the above embodiment can open the lens barrier 12 in response to the voice sensor 17 recognizing a loud voice of a predetermined volume or larger, such as a scream of a person or a sound of a traffic accident. With this processing, the imaging device 1 can more effectively capture images in an intended situation while providing privacy protection.

The imaging device 1 according to the first modification includes the odor sensor 18, and opens the lens barrier 12 to capture images in response to the odor sensor 18 detecting a predetermined odor. When, for example, detecting an odor of a specific person, the imaging device 1 can open the lens barrier 12 to capture images in an intended situation while providing privacy protection.

The imaging device 1 according to the second modification includes the vibration sensor 19, and opens the lens barrier 12 to capture images in response to the vibration sensor 19 detecting vibrations. When, for example, detecting a visitor with vibrations or detecting an accident with a shock, the imaging device 1 can open the lens barrier to capture images in an intended situation while providing privacy protection.

The imaging device 1 according to the third modification can detect a human body with the infrared sensor 20, and opens the lens barrier 12 to capture images when detecting a human body. For example, when detecting a visitor, the imaging device 1 can open the lens barrier 12 to capture images in an intended situation while providing privacy protection.

The infrared sensor 20 is an example of a device that detects a human body. A human sensor other than the infrared sensor 20 may be used.

The imaging device 1 according to each of the above embodiment and the first to third modifications may be installed adjacent to a home or office door. The imaging device 1 installed adjacent to a home or office door can be in a system that captures images of visitors and passersby as appropriate. The imaging device 1 may help reduce crimes near the home or office or may be used to identify the causes of accidents.

In the imaging device 1 according to each of the above embodiment and the first to third modifications, the surface of the lens barrier 12 facing a subject may be colored or have a sign or a pattern. The imaging device 1 with this structure allows a person to clearly notice whether his or her image is being captured. This may more effectively reduce crimes.

Embodiments and modifications of the present invention have been described specifically. The embodiments and modifications described above are mere examples of structures and operations. The scope of the present invention is not limited to the embodiments and modifications, but is construed broadly within the scope understandable by those skilled in the art.

The specific processes described in the embodiment are mere examples, and similar processes with similar effects may be used.

The components in the first embodiment and the first to third modifications may be combined with one another. For example, the structure may include the voice sensor 17 and the odor sensor 18 in combination.

The processes in the first embodiment and the first to third modifications may be combined with one another. For example, the process for starting image capturing in response to detecting a predetermined odor in the first modification may further include the processing in steps S130 to S132 for identifying a captured person.

### INDUSTRIAL APPLICABILITY

The imaging device according to one or more embodiments of the present invention may be installed adjacent to a highly secure home door or may be used as a surveillance camera.

What is claimed is:

1. An imaging device, comprising:
an imaging unit configured to capture an image;
a lens barrier configured to open and close the imaging unit;
a lens barrier driver configured to drive the lens barrier;
a voice sensor configured to recognize a voice; and
an information processor configured to control the lens barrier driver to open the lens barrier in response to the voice sensor recognizing a predetermined voice.

2. The imaging device according to claim 1, wherein
the information processor controls the lens barrier driver to open the lens barrier in response to the voice sensor recognizing a predetermined keyword.

3. The imaging device according to claim 2, wherein
the information processor controls the lens barrier driver to open the lens barrier in response to the voice sensor recognizing a voice of a predetermined volume or larger.

4. An imaging device, comprising:
an imaging unit configured to capture an image;
a lens barrier configured to open and close the imaging unit;
a lens barrier driver configured to drive the lens barrier;
an odor sensor configured to detect an odor; and
an information processor configured to control the lens barrier driver to open the lens barrier in response to the odor sensor detecting a predetermined odor.

5. An imaging device, comprising:
an imaging unit configured to capture an image;
a lens barrier configured to open and close the imaging unit;
a lens barrier driver configured to drive the lens barrier;
a vibration sensor configured to detect vibrations; and
an information processor configured to control the lens barrier driver to open the lens barrier in response to the vibration sensor detecting vibrations.

6. An imaging device, comprising:
an imaging unit configured to capture an image;
a lens barrier configured to open and close the imaging unit;
a lens barrier driver configured to drive the lens barrier;
a human sensor configured to detect a human body; and
an information processor configured to control the lens barrier driver to open the lens barrier in response to the human sensor detecting a human body.

7. An imaging system, comprising:
a door openable and closeable; and
the imaging device according to claim 1,
wherein the imaging unit is installed adjacent to the door.

8. The imaging system according to claim 7, wherein
a surface of the lens barrier facing a subject is colored or has a sign or a pattern.
